(19) United States
(12) Patent Application Publication
(10) Pub. No.: US 2006/0230132 A1
(43) Pub. Date: Oct. 12, 2006

(54) System and method for selective installation of a network document processing device

(76) Inventors: Vikas Dogra, Lake Forest, CA (US); Manoj K. Verma, Lake Forest, CA (US); Sanjay Wangoo, Lake Forest, CA (US); Ashutosh S. Gijare, Lake Forest, CA (US); George Koppich, Palos Verdes Est., CA (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/450,224

(22) Filed: Jun. 9, 2006

Related U.S. Application Data
(63) Continuation-in-part of application No. 10/125,886, filed on Apr. 19, 2002, now abandoned.

(51) Int. Cl. G06F 15/173

(52) U.S. Cl. 709/223

(57) ABSTRACT

A system and method for selective installation of a network document processing device. Data representing available networked document processing devices is first communicated to a network, whereupon a visual indication of one of the document processing devices is displayed on a thin client interface. The thin client interface then receives, from an associated user, a selection of one of the available document processing devices. The thin client device then communicates this selection data to a storage, which has stored various device drivers, each associated with at least one of the available document processing devices. The device driver corresponding to the selection data is then retrieved from the storage and sent to the thin client device, which is resident on a workstation. The driver is then installed and the thin client device is able to request document processing operations by the selected document processing device.

### CROSS-REFERENCE TO RELATED APPLICATIONS

This application is a continuation-in-part of U.S. patent application Ser. No. 10/125,886, titled BROWSER-IMPLEMENTED UPLOAD/DOWNLOAD OF A DRIVER, filed on Apr. 19, 2002.

### BACKGROUND OF THE INVENTION

The subject application is directed to a system and method for browser-implemented uploading and downloading of a device driver. More particularly, the subject application is directed to a system and method for selective installation of network document processing devices.

In a typical computer network environment, multifunction peripheral devices, or document processing devices, are generally shared among a variety of user devices. In order for these user devices to effectively communicate with the shared document processing devices, each user device must have a device driver, associated with each document processing device. The device driver advantageously enables the operating system of the user device to communicate with the hardware of the document processing device. As new document processing devices are added to the network environment, a new device driver must be installed on the user device corresponding to the new document processing device. In typical fashion, the new device driver must be installed manually, requiring the user to select the driver to be associated with the new document processing device and installing the driver on the user device. This process requires the user to have considerable knowledge of the appropriate driver to install, access rights to install the driver on the user device, as well as access to the needed driver.

Further issues complicating this process are the various operating systems, i.e., Windows®-based operating systems on the user devices and Linux®-based operating systems on the document processing devices. In addition, the typical computer network environment contains two types of user devices, a thick client user device and a thin client user device. The thick client user device refers to a user device operating through a printer driver, whereas the thin client user device references a user device operating though a web browser. However, for both types of user devices, a device driver must eventually be used to facilitate communications between the user device and a document processing device.

The subject application overcomes the above mentioned problems and provides a system and method for selective installation of a network document processing device.

### SUMMARY OF THE INVENTION

In accordance with the subject application, there is provided a system and method for selective installation of a network document processing device.

Still further, in accordance with the subject application, there is provided a system and method for browser-implemented uploading and downloading of a device driver.

In accordance with the subject application, there is provided a system for selective installation of a network document processing device. The system includes communication means adapted to communicate device data representing available networked document processing devices to a computer network. The system further includes a workstation in data communication with the network, with the workstation including a thin client interface. The system also includes a display means adapted to display a visual indication of one available networked document processor, and receiving means adapted for receiving selection data, via the thin client interface, of one of the available document processors. A storage is also incorporated in the system, suitably including driver data associated with each of the networked document processing devices. The system further includes communications means adapted to communicate the selection data to the storage via the network, and communication means adapted to communicate the driver data corresponding to the selection data from the storage to the workstation via the network. In addition, the system includes installation means adapted to install the driver data in the workstation so as to enable the workstation to use the selected document processing device via the network.

Still further, in accordance with the subject application, there is provided a method for selective installation of a network document processing device. The method begins by communicating device data representing available networked document processing devices to a network. Next, a visual indication of one of the available networked processors is then displayed on the thin client interface according to the device data received via the network. The thin client interface then receives selection data representing the document processor selected from the available document processing devices. Driver data, associated with each of the available networked document processing devices, that has been stored in a storage and the selection data is communicated to the storage via the computer network. The driver data, corresponding to the selection data, is then communicated from the storage to an associated workstation via the network. The driver data is then installed in the workstation so as to enable use by the workstation of the at least one selected document processor via the network.

In one embodiment, the driver data includes queue formation data for forming a queue, and further comprising the step of creating a queue in accordance with the queue formation data which queue communicates document processing jobs to the at least one selected document processor.

In another embodiment, the networked document processing device includes a printer.

In a further embodiment, the thin client interface is a web browser.

Still other advantages, aspects and features of the present invention will become readily apparent to those skilled in the art from the following description wherein there is shown and described a preferred embodiment of this invention, simply by way of illustration of one of the best modes best suited to carry out the invention. As it will be realized, the invention is capable of other different embodiments and its several details are capable of modifications in various obvious aspects all without departing from the scope of the invention. Accordingly, the drawings and descriptions will be regarded as illustrative in nature and not as restrictive.

### BRIEF DESCRIPTION OF THE DRAWINGS

The subject invention is described with reference to certain figures, including:

FIG. 1 which is an overall system diagram of the system for selective installation of a network document processing device according to the subject application;

FIG. 2 is a flowchart illustrating the method for selective installation of a network document processing device from an administrative side according to the subject application; and

FIG. 3 is a flowchart illustrating the method for selective installation of a network document processing device from a user side according to the subject application.

### DETAILED DESCRIPTION OF THE PREFERRED EMBODIMENT

The subject application is directed a system and method for selective installation of a network document processing device. In particular, the subject application is directed to a system and method for browser-implemented uploading and downloading of a device driver. More particularly, the subject application is directed to a system and method for browser-implemented uploading of a device driver from an administrator device to a print server and downloading from a print server to a thin client device. As will be appreciated by those of ordinary skill in the art, the term “thin client device” is used interchangeably herein with a user device, as set forth below. It will further be understood by those skilled in the art that the functioning of the user device, as discussed below, is advantageously accomplished using a web browser.

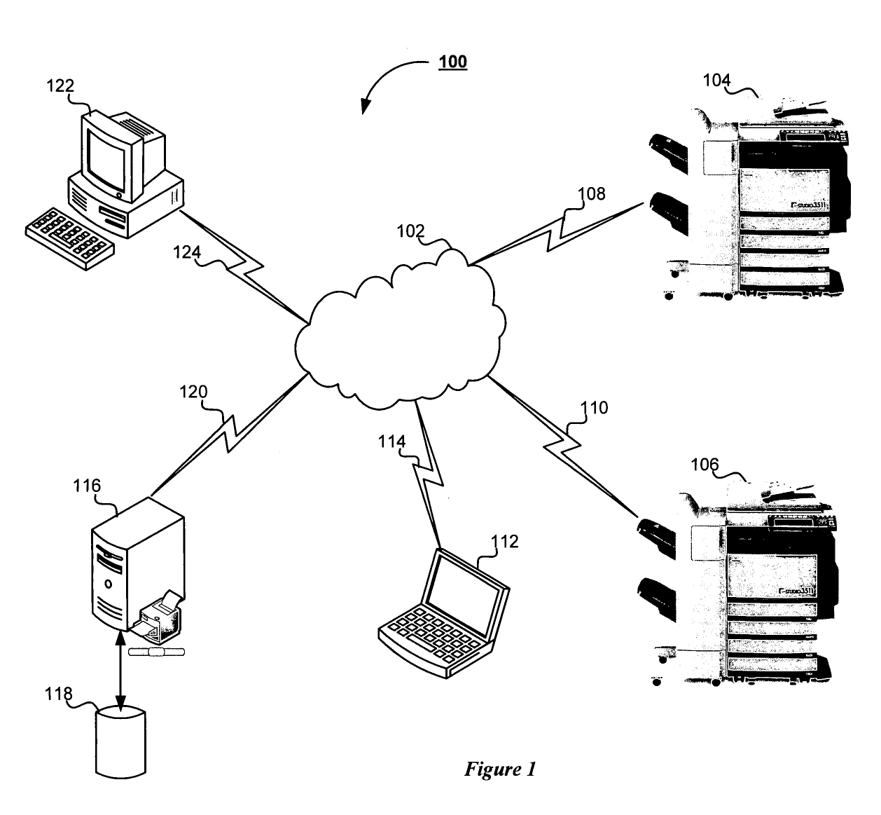

Referring now to FIG. 1, there is shown a diagram illustrating an overall system 100 for selective installation of a network document processing device in accordance with the subject application. The system 100 includes a distributed computing environment, represented in FIG. 1 as a computer network 102. It will be appreciated by those skilled in the art that the computer network 102 is any distributed communications environment known in the art capable of allowing two or more electronic devices to exchange data. The skilled artisan will understand that the computer network 102 is any computer network, known in the art, including for example and without limitation, a personal area network, a local area network, a virtual network, a wide area network, an intranet, the Internet, or any suitable combination thereof. In the preferred embodiment of the subject application, the computer network 102 is comprised of physical layers and transport layers, as illustrated by the myriad of conventional data transport mechanisms, both secured and open, such as, for example and without limitation, Ethernet, 802.11(x), Token-Ring, or other wired or wireless data communication mechanisms. Preferably, the computer network 102 is capable of employing one or more security protocols to provide secure data communications between electronic devices communicatively coupled thereto.

As shown in FIG. 1, the system 100 also includes one or more document processing devices 104 and 106, represented as multifunction peripheral devices. It will be understood by those skilled in the art that the document processing devices 104 and 106 are suitably adapted to provide a variety of document processing services, such as, for example and without limitation, electronic mail, scanning, copying, facsimile, document management, printing, and the like. In one embodiment of the subject application, the document processing devices 104 and 106 further include hardware, software, or any combination thereof, suitably adapted to function as a certificate authority. Suitable commercially available document processing devices include, but are not limited to, the Toshiba e-Studio Series Controller. In one embodiment, the document processing devices 104 and 106 are suitably equipped to receive a plurality of portable storage media, including without limitation, Firewire drive, USB drive, SD, MMC, XD, Compact Flash, Memory Stick, and the like. In the preferred embodiment of the present invention, the document processing devices 104 and 106 further include an associated user-interface, such as a touch-screen interface, LCD display, or the like, via which an associated user is able to interact directly with the document processing devices 104 and 106.

In accordance with the preferred embodiment of the subject application, the document processing device 104 is in data communication with the computer network 102 via a suitable communications link 108; and the document processing device 106 is in data communication with the computer network 102 via a suitable communications link 110. As will be appreciated by the skilled artisan, the communications links 108 and 110 employed in accordance with the present invention include, WiMax, 802.11a, 802.11b, 802.11g, 802.11(x), Bluetooth, the public switched telephone network, a proprietary communications network, infrared, optical, or any other suitable wired or wireless data transmission communications known in the art. The skilled artisan will further appreciate that the communications links 108 and 110 are capable of employing any of a plurality of security protocols for secure data communications, as are known in the art.

The system 100, as illustrated in FIG. 1, further includes an administrator device 112. It will be understood by those skilled in the art that the use of the device 112 is representative of any system or network administrator, suitably capable of providing administrative access to the network 102, the document processing device 104, document processing device 106, and other devices communicatively coupled to the computer network 102. Preferably, the administrator device 112 is suitably adapted to provide device drivers corresponding to the document processing devices 104 and 106. As will be appreciated by those skilled in the art, a device driver is a computer program suitably adapted to enable another program, such as an operating system, to interact with a hardware device. Stated another way, using the administrator device 112, a system or network administrator is able to select various device drivers to be associated with the document processing devices 104 and 106. It will be appreciated by those skilled in the art that the administrator device 112 is depicted in FIG. 1 as a laptop computer for illustration purposes only. As the skilled artisan will understand, the administrator device 112 shown in FIG. 1 is representative of any personal computing device known in the art, including, for example and without limitation, a web-enabled cellular telephone, a smart phone, a personal computer, a computer workstation, a personal data assistant, or other web-enabled electronic device suitably capable of performing administrative duties consistent with the administration of a computer network 102.

In accordance with one embodiment of the subject application, the administrator device 112 further includes data storage capable of storing a variety of device drivers, portable media receptacles, i.e., CD-ROM drive, USB ports, Firewire ports, floppy, memory card, and the like, or other means of storing and accessing device drivers known in the art. In the preferred embodiment of the subject application, the administrator device 112 is communicatively coupled to the computer network 102 via a communications link 114. The communications link 114 is any suitable communications channel known in the art enabling the two-way communication of data including, for example and without limitation, 802.11a, 802.11b, 802.11g, 802.11(x), Bluetooth, WiMax, a proprietary communications channel, infrared, optical, the public switched telephone network, or any other suitable wire-based or wireless data transmission communications known in the art.

The system 100 also employs a print server 116 suitably adapted to receive, store, and supply device drivers associated with document processing devices 104 and 106 communicatively coupled to the computer network 102. Preferably, the print server 116 is an image service platform server, running a Linux® platform. As will be appreciated by those skilled in the art, the print server 116 is capable of implementation on a variety of different platforms, including, for example and without limitation, Microsoft Corporation server products, or the like. The print server 116 is capable of implementation as any hardware, software, or suitable combination thereof, able to perform the functions described hereinafter. In accordance with the preferred embodiment of the subject application, the print server 116 is communicatively coupled to the computer network 102 via a communications link 120. Preferably, the communications link 120 is any suitable communications channel known in the art enabling the two-way communication of data including, for example and without limitation, Bluetooth, a proprietary communications channel, infrared, WiMax, 802.11a, 802.11b, 802.11g, 802.11(x), optical, the public switched telephone network, or any other suitable wire-based or wireless data transmission communications known in the art. The skilled artisan will appreciate that other server-type platforms are equally capable of being implemented in accordance with the methodologies described herein.

Operatively coupled to the print server 116 is a data storage device 118, suitably adapted to provide data storage of device drivers, associations between drivers and devices, and the like. Preferably, the data storage device 118 functions as a library or device drivers and their respective associations with document processing devices resident on the computer network 102. As will be appreciated by those skilled in the art, the data storage device 118 is any mass storage device known in the art including, for example and without limitation, a hard disk drive, other magnetic storage devices, optical storage devices, flash memory devices, or any combination thereof. In accordance with one embodiment of the subject application, the data storage device 118 is an internal hard disk drive of the print server 116. In accordance with one particular embodiment of the subject application, the data storage device 118 is operatively coupled to the computer network 102, such that the print server 116 accesses the data storage device 118 via the computer network 102. As will be explained in greater detail below, the administrator associated with the administrator device 112 is capable of uploading, via HTTP Request/Response, or the like, drivers to be associated with a document processing device 104 or 106 identified in the library on the data storage device 118.

The system 100 illustrated in FIG. 1 further includes at least one user device 122. Preferably, the user device 122 is communicatively coupled to the computer network 102 via a suitable communications link 124. It will be appreciated by those skilled in the art that the user device 122 is depicted in FIG. 1 as a workstation computer for illustration purposes only. As the skilled artisan will understand, the user device 122 shown in FIG. 1 is representative of any personal computing device known in the art, including, for example and without limitation, a laptop computer, a personal computer, a personal data assistant, a web-enabled cellular telephone, a smart phone, or other web-enabled electronic device suitably capable of generating and/or transmitting electronic document data to a multifunctional peripheral device. In the preferred embodiment, the user device 122 is suitably adapted to generate document processing requests to the document processing devices 104 and 106, as will be explained in greater detail below. Preferably, the user device 122 includes hardware, software, or any suitable combination thereof, capable of allowing an associated user to request a device driver associated with a selected document processing device 104 or 106, as well as request the performance of document processing operations.

The communications link 124 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. In accordance with the preferred embodiment of the subject application, the user device 122 uses a Windows®-based operating system, such that a browser client running on this platform facilitates the acquisition of device drivers corresponding to a selected document processing device 104 or 106. It will be understood by those skilled in the art that web browser operating on the user device 122 facilitates and/or performs the functionality of the device 122 in accordance with the methodologies described hereinafter.

In operation, each document processing device 104 and 106 requires that a user device 122 requesting document processing operations must first acquire a suitable device driver, thereby allowing the operating system of the user device 122 to interact with the hardware associated with the document processing device 104 or 106. In order for the user device 122 to access the correct driver, the driver must first be made available on the print server 116 for downloading by the user device 122. Thus, an administrator associated with the administrator device 112 first accesses the print server 116 via any suitable means known in the art. Preferably, the administrator device 112 receives a listing of all available queues, i.e., document processing devices 104 and 106, currently on the computer network 102. In accordance with the preferred embodiment of the subject application, the print server 116 advantageously maintains a listing of each document processing device 104 and 106 on the computer network 102, with each new document processing device recognized by the server 116 via any suitable means known in the art. From this listing of available document processing devices on the computer network 102, the administrator selects one of the devices 104 or 106 for which a device driver is to be uploaded. Preferably, the administrator selects a queue, i.e., document processing device, and via an ActiveX/Applet selects the desired device driver to associate with the selected document processing device.

The selected device driver is then uploaded from the administrator device 112, via any suitable means known in the art, to the print server 116. The print server 116 then associates the received device driver with the selected document processing device 104 or 106 and stores the device driver on the data storage device 118. The skilled artisan will appreciate that this process is repeated by the administrator, via the administrator device 112, for each document processing device 102 on the computer network 102 for which the administrator desires to upload a device driver.

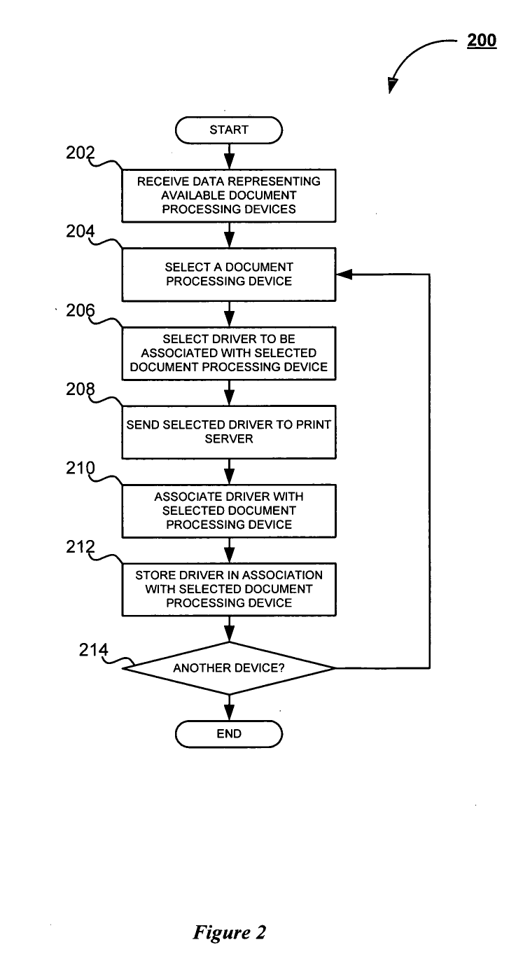

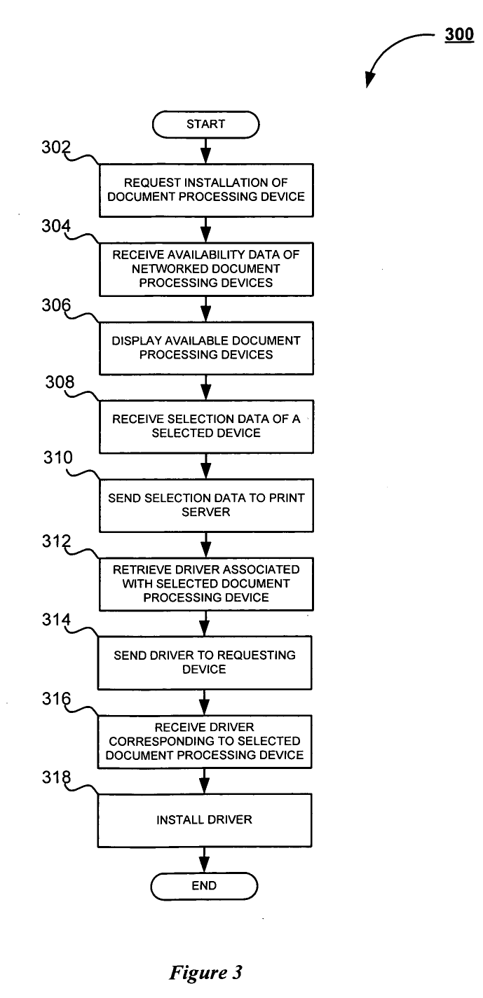

When the user associated with the user device 122 desires to request a document processing operation, the user first selects the desired document processing device 104 or 106. Preferably, this selection is made via an HTTP Request/Response to the print server 116 over the computer network 102. In accordance with the preferred embodiment of the subject application, the print server 116, in response to a request from the user device 122, transmits a list of available document processing devices 104 and 106. The user associated with the user device 122 selects one of the available document processing devices 104 and 106 to be installed on the user device 122. The skilled artisan will appreciate that the preceding statement corresponds to the installation of a document processing device driver on the user device 122, thereby enabling the user device 122 to effectively communicate with the document processing device associated with the driver. Selection of the desired document processing device 104 or 106 prompts the print server 116 to locate the device driver associated with the selected device 104 or 106. The device driver is then downloaded by the user device 122 and installed on the user device 122. Preferably, the driver is downloaded and via an ActiveX/Applet, the driver is installed on the user device 122. The operation of the foregoing system 100 will better be understood when viewed in conjunction with the methodologies embodied in the flowcharts of FIG. 2 and FIG. 3.

Turning now to FIG. 2, there is shown a flowchart 200 illustrating the method for selective installation of a network document processing device from an administrative side in accordance with the subject application. Beginning at step 202, the administrator device 112 receives data representative of available document processing devices 104 and 106 on the computer network 102. Preferably, this data is received from the print server 116 via an HTTP Request/Response exchange. At step 204, an administrator associated with the administrator device 112 selects one of the available document processing devices 104 or 106 from the listing of available document processing devices 104 and 106. The administrator then selects a device driver to be associated with the selected document processing device 104 or 106 at step 206. In accordance with the preferred embodiment of the subject application, the administrator device 112 includes one or more device drivers suitably adapted to correspond to one or more document processing devices 104, 106, located on the computer network 102. In addition, the administrator device 112 is further capable of using a CD-ROM containing a device driver, a memory card, a network location, or the like. In accordance with the preferred embodiment, the selection of the desired driver is advantageously made via an ActiveX/Applet, as will be understood by those skilled in the art.

Once the administrator has identified the device driver to be associated with the selected document processing device 104 or 106, the administrator device 112 sends the selected device driver to the print server 116 at step 208. It will be appreciated by those skilled in the art that in an alternate embodiment, the driver is loaded directly on the print server 116, such that the administrator selects the driver from among those drivers available on the print server 116. At step 210, the print server 116 associates the received device driver with the selected document processing device 104 or 106, in accordance with the selections made by the administrator. The device driver is stored in association with the designated document processing device 104 or 106 at step 212. A determination is then made at step 214 whether the administrator desires to associate another device driver with another document processing device. A positive determination at step 214 prompts the return to step 204, whereupon the administrator selects one of the available document processing devices 104 and 106. Thereafter, operations continue as set forth above in steps 206-212. When a negative determination is made at step 214, the administrator-side of the operation terminates.

Referring now to FIG. 3, there is shown a flowchart 300 illustrating the method for selective installation of a network document processing device from a user side in accordance with the subject application. The method of FIG. 3 begins at step 302, whereupon a user associated with the user device 122 requests the installation of a document processing device 104 or 106. As the skilled artisan will appreciate, such installation request is advantageously accomplished via an installation wizard, or the like. Preferably, the installation request is initiated using a thin client, i.e., browser, running on the Windows®-based user device 122. This request is submitted to the print server 116 via any suitable means. Alternatively, the skilled artisan will appreciate that such an installation request is capable of being intercepted by the print server 116, via any suitable means known in the art. The browser on the user device 122 then receives, at step 304, data representative of the document processing devices 104 and 106 available on the computer network 102. Preferably, this data is in the form of a response to an HTTP request, such that print server 116 retrieves the data from the data storage device 118 and returns the list to the user device 122.

At step 306, the available devices returned by the print server 116 are then displayed to the user associated with the user device 122. A selection of a desired document processing device 104 or 106 is then received from the associated user at step 308, whereupon the selection data, representing the document processing device 104 or 106 selected by the user, is sent to the print server 116 at step 310. At step 312, the print server 116 retrieves the device driver associated with the selected document processing device 104 or 106 from the data storage device 118. The retrieved device driver is then sent to the requesting user device 122 at step 314. At step 316, the requesting user device 122 receives the device driver corresponding to the selected document processing device 104 or 106 and thereafter installs the driver at step 318. Preferably, this installation of the downloaded driver is accomplished via an ActiveX/Applet operating on the browser of the user device 122. It will be understood by those skilled in the art that such installation thereby enables the user device 122 to submit document processing requests to the document processing device 104 or 106 in a form that the processing device 104 or 106 is able to understand.

The invention extends to computer programs in the form of source code, object code, code intermediate sources and partially compiled object code, or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for selective installation of a network document processing device comprising:
means adapted for communicating device data representative of a plurality of available networked document processing devices to a network;
a workstation in data communication with the network, the workstation including a thin client interface;
means adapted for displaying, on the thin client interface, a visual indication of at least one available networked document processor in accordance with device data received via the network;
means adapted for receiving, via the thin client interface, selection data representative of at least one selected document processor selected from the available networked document processing devices;
a storage comprising driver data associated with each of the available networked document processing devices;
means adapted for communicating the selection data to the storage via the network;
means adapted for communicating driver data, corresponding to the selection data, from the storage to the workstation via the network; and
means adapted for installing the driver data in the workstation so as to enable use by the workstation of the at least one selected document processor via the network.

2. The system for selective installation of a network document processing device of claim 1 wherein the driver data includes queue formation data for forming a queue, and further comprising queue formation means adapted for creating a queue in accordance with the queue formation data which queue communicates document processing jobs to the at least one selected document processor.

3. The system for selective installation of a network document processing device of claim 2 wherein the networked document processing device includes a printer.

4. The system for selective installation of a network document processing device of claim 1 wherein the thin client interface is a web browser.

5. A method for selective installation of a network document processing device comprising the steps of:
communicating device data representative of a plurality of available networked document processing devices to a network;
displaying, on a thin client interface, a visual indication of at least one available networked document processor in accordance with device data received via the network;
receiving, via the thin client interface, selection data representative of at least one selected document processor selected from the available networked document processing devices;
storing driver data associated with each of the available networked document processing devices in a storage;
communicating the selection data to the storage via the network;
communicating driver data, corresponding to the selection data, from the storage to an associated workstation via the network; and
installing the driver data in the workstation so as to enable use by the workstation of the at least one selected document processor via the network.

6. The method for selective installation of a network document processing device of claim 5 wherein the driver data includes queue formation data for forming a queue, and further comprising the step of creating a queue in accordance with the queue formation data which queue communicates document processing jobs to the at least one selected document processor.

7. The method for selective installation of a network document processing device of claim 6 wherein the networked document processing device includes a printer.

8. The method for selective installation of a network document processing device of claim 5 wherein the thin client interface is a web browser.

9. A computer-implemented method for selective installation of a network document processing device comprising the steps of:
communicating device data representative of a plurality of available networked document processing devices to a network;
displaying, on a thin client interface, a visual indication of at least one available networked document processor in accordance with device data received via the network;
receiving, via the thin client interface, selection data representative of at least one selected document processor selected from the available networked document processing devices;
storing driver data associated with each of the available networked document processing devices in a storage;
communicating the selection data to the storage via the network;
communicating driver data, corresponding to the selection data, from the storage to an associated workstation via the network; and
installing the driver data in the workstation so as to enable use by the workstation of the at least one selected document processor via the network.

10. The computer-implemented method for selective installation of a network document processing device of claim 9 wherein the driver data includes queue formation data for forming a queue, and further comprising the step of creating a queue in accordance with the queue formation data which queue communicates document processing jobs to the at least one selected document processor.

11. The computer-implemented method for selective installation of a network document processing device of claim 10 wherein the networked document processing device includes a printer.

12. The computer-implemented method for selective installation of a network document processing device of claim 9 wherein the thin client interface is a web browser.
